(19) United States
(12) Patent Application Publication
(10) Pub. No.: US 2014/0004431 A1
(43) Pub. Date: Jan. 2, 2014

(54) ALUMINIUM AIR BATTERY

(71) Applicants: Takitaro Yamaguchi, Tsukuba-shi (JP); Takashi Sanada, Chuo-ku (JP)

(72) Inventors: Takitaro Yamaguchi, Tsukuba-shi (JP); Takashi Sanada, Chuo-ku (JP)

(73) Assignee: SUMITOMO CHEMICAL COMPANY, LIMITED, Chuo-ku, Tokyo (JP)

(21) Appl. No.: 13/980,112

(22) PCT Filed: Dec. 27, 2011
(86) PCT No.: PCT/JP2011/080320

§ 371 Date: Sep. 16, 2013

(30) Foreign Application Priority Data
Jan. 19, 2011 (JP) 2011-008516

(51) Int. Cl. H01M 12/06

(52) U.S. Cl. CPC H01M 12/06
USPC 429/405

(57) ABSTRACT

An object of the invention is to provide an aluminum air battery that is capable of suppressing self-corrosion of an aluminum negative electrode, even when an alkaline aqueous solution is used as an electrolyte solution. The aluminum air battery of this invention comprises a positive electrode having a positive electrode catalyst, a negative electrode using an aluminum alloy, an air inlet, and an electrolyte solution, and further comprises an anion-exchange membrane arranged between the positive electrode and the negative electrode, in which the anion-exchange membrane separates an electrolyte solution in the side of the positive electrode from an electrolyte solution in the side of the negative electrode.

### TECHNICAL FIELD

The present invention relates to an aluminum air battery.

### BACKGROUND ART

An aluminum air battery is a battery which uses oxygen in the air as a positive electrode active material.

In the air battery, a negative electrode active material is generally an aluminum alloy, and produces metal oxide or metal hydroxide due to a discharge reaction.

As an electrolyte solution of an aluminum air battery, a neutral aqueous solution having NaCl, AlCl₃, MnCl₂, or the like dissolved in water or an alkaline aqueous solution having NaOH, KOH, or the like dissolved in water has been conventionally used as an electrolyte.

However, when a neutral aqueous solution is used as an electrolyte solution, since an oxide film on an aluminum alloy negative electrode is insoluble in the neutral aqueous solution, it is disadvantageous in that a battery is operated in a state with a load and thus the operation voltage and current efficiency are lowered.

Meanwhile, when an alkaline aqueous solution is used as an electrolyte solution, although the operation voltage and current efficiency of a battery are high, the problem is that corrosion (so-called self-corrosion) of an aluminum alloy negative electrode in a state in which no load is applied to the battery, i.e., self-discharge, is high.

In order to solve the problems described above, for an aluminum air battery using an alkaline aqueous solution as an electrolyte solution, it has been suggested to include a polymer compound having a quaternary ammonium group in an electrolyte, for example (see Patent Literature 1, for example).

### CITATION LIST

### Patent Literature

Patent Literature 1: Japanese Patent Application Laid-Open Publication No. S55-062661

### SUMMARY OF INVENTION

### Technical Problem

However, an aluminum air battery having an electrolyte in which a polymer compound having a quaternary ammonium group is included has a problem that suppression of its aluminum alloy corrosion is not sufficient so that self-discharge is high.

Under the circumstances, an object of the invention is to provide an aluminum air battery that is capable of suppressing self-corrosion of an aluminum alloy in a negative electrode, even when an alkaline aqueous solution is used as an electrolyte solution.

### Solution to Problem

The inventors have conducted intensive studies to solve the problems described above, and as a result completed the invention described below.

An embodiment of the invention is an aluminum air battery comprising a positive electrode having a positive electrode catalyst, a negative electrode using an aluminum alloy, an air inlet, and an electrolyte solution, and comprising an anion-exchange membrane arranged between the positive electrode and the negative electrode; wherein the anion-exchange membrane separates an electrolyte solution in the side of the positive electrode from an electrolyte solution in the side of the negative electrode.

In the above embodiment, the anion-exchange membrane preferably has an anion-exchange capacity of 0.5 to 3.0 milliequivalents/g (mEq/g).

In the above embodiment, it is preferable that the anion-exchange membrane be an anion-exchange resin selected from the group consisting of polysulfone (PS), polyether sulfone (PES), polyphenyl sulfone (PPS), polyvinylidene fluoride (PVdF), polyimide (PI), and a mixture thereof.

In the above embodiment, it is preferable that the anion-exchange membrane be an anion-exchange resin selected from the group consisting of styrene, divinylbenzene, a mixture thereof, and a copolymer thereof.

In the above embodiment, it is preferable that the electrolyte solution in the side of the positive electrode, the solution having been separated by the anion-exchange membrane, should have a hydrogen ion concentration different from a hydrogen ion concentration the electrolyte solution in the side of the negative electrode has.

In the above embodiment, it is preferable that the electrolyte solution be an aqueous solution containing as an electrolyte at least one selected from the group consisting of KOH, NaOH, LiOH, Ba(OH)₂, and Mg(OH)₂.

In the above embodiment, it is preferable that the positive electrode catalyst contain manganese dioxide or platinum.

In the above embodiment, it is preferable that the positive electrode catalyst contain Perovskite type composite oxide represented by ABO₃ in which the A site includes two or more elements selected from the group consisting of La, Sr, and Ca and the B site includes one or more elements selected from the group consisting of Mn, Fe, Cr, and Co.

In the above embodiment, it is preferable that the aluminum alloy used for the negative electrode have a magnesium content of 0.0001% by weight to 8% by weight, the aluminum alloy satisfy at least one or more of the following conditions (A) or (B), and of among the elements contained in the aluminum alloy, a content of each element other than aluminum, magnesium, silicon, and iron be 0.005% by weight or less for each,

condition (A): the aluminum alloy has an iron content of 0.0001% by weight to 0.03% by weight, and

condition (B): the aluminum alloy has a silicon content of 0.0001% by weight to 0.02% by weight.

In the above embodiment, it is preferable that the aluminum alloy have a total content of elements other than aluminum and magnesium of 0.1% by weight or less.

In the above embodiment, it is preferable that the aluminum alloy contain intermetallic compound particles in an alloy matrix, and of among the intermetallic compound particles observed in the surface of the aluminum alloy, a density of the intermetallic compound particles having cross sectional area of 0.1 μm² or more and less than 100 μm² be 1000 particles/mm² or less, a density of the intermetallic compound particles having cross sectional area of 100 μm² or more be 10 particles/mm² or less, and an area of occupancy of the intermetallic compound particles per unit surface area of the aluminum alloy be 0.5% or less.

In the above embodiment, it is preferable that an oxygen selective permeable membrane be installed so that oxygen taken into the air inlet can permeate to reach the positive electrode.

In the above embodiment, it is preferable that the electrolyte solution have a contact angle with the surface of the oxygen selective permeable membrane of 90° or more. Alternatively, it is preferable that the electrolyte solution have a contact angle with the surface of the oxygen selective permeable membrane of 150° or more.

In the above embodiment, it is preferable that the oxygen selective permeable membrane have an oxygen selective coefficient (PO₂) of 400×10⁻¹⁰ cm³·cm/cm²·s·cmHg or more.

In the above embodiment, it is preferable that PO₂/PCO₂, which is a ratio of the oxygen selective coefficient PO₂ of the oxygen selective permeable membrane to a carbon dioxide selective coefficient PCO₂ of the oxygen selective permeable membrane, be 0.15 or more. Hereinafter, depending on a case, the PO₂/PCO₂ is described as “oxygen/carbon dioxide selective permeability”.

In the above embodiment, it is preferable that the electrolyte solution circulate.

### Advantageous Effects of Invention

According to the invention, an aluminum air battery that is capable of easily suppressing self-corrosion of an aluminum alloy in a negative electrode is provided.

### BRIEF DESCRIPTION OF DRAWINGS

FIG. 1(A) is a schematic diagram illustrating a positive electrode catalyst of a positive electrode that is used for an air battery according to an embodiment of the invention, FIG. 1(B) is a schematic diagram illustrating a stainless mesh used for a positive electrode current collector, and FIG. 1(C) is a schematic diagram illustrating an oxygen diffusion membrane.

FIG. 2 is a schematic diagram illustrating a stainless mesh (positive electrode current collector) of FIG. 1(B) and a nickel ribbon welded to the positive electrode current collector.

FIG. 3 is a schematic diagram illustrating a positive electrode which has the positive electrode current collector of FIG. 2 and a positive electrode catalyst being in contact with the surface of the positive electrode current collector.

FIG. 4 is a schematic diagram illustrating the positive electrode of FIG. 3 which is additionally applied with an oxygen diffusion membrane and also has holes formed at six spots.

FIG. 5(A) is a schematic diagram illustrating an aluminum alloy used for a negative electrode of an air battery according to an embodiment of the invention, FIG. 5(B) is a schematic diagram illustrating the aluminum alloy of FIG. 5(A) having an imide tape attached to one surface, and FIG. 5(C) is a schematic diagram illustrating the aluminum alloy of FIG. 5(B) to which a lead wire is further attached.

FIG. 6 is a schematic diagram illustrating a rubber packing with holes that is used for an air battery according to an embodiment of the invention.

FIG. 7 is a schematic diagram illustrating another rubber packing with holes that is used for an air battery according to an embodiment of the invention.

FIG. 8 is a schematic diagram illustrating a negative electrode bath frame that is used for an air battery according to an embodiment of the invention.

FIG. 9 is a schematic diagram illustrating a positive electrode cover having air inlets formed at nine spots, which is used for an air battery according to an embodiment of the invention.

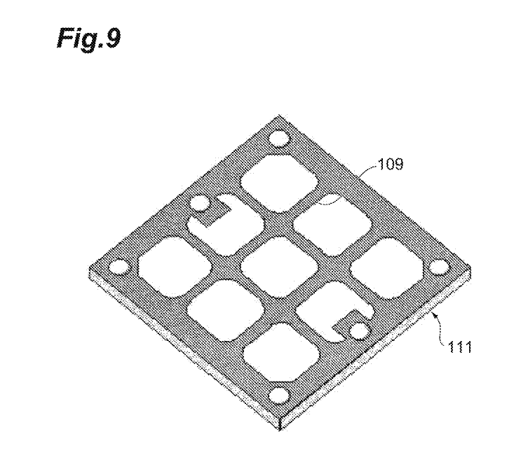

FIG. 10 is a schematic diagram illustrating an anion-exchange membrane having holes formed at four corners, which is used for an air battery according to an embodiment of the invention.

FIG. 11 is a schematic diagram illustrating an order of stacking each constituent component for the process of fabricating an air battery according to an embodiment of the invention.

FIG. 12(A) is a schematic diagram illustrating the surface side of a positive electrode side unit (laminate), which is used for an air battery according to an embodiment of the invention, and FIG. 12(B) is a schematic diagram illustrating the back side of the laminate of FIG. 12(A).

FIG. 13 is a schematic diagram illustrating the process of laminating a negative electrode and a negative electrode cover on the back side of the positive electrode side unit shown in FIG. 12(B).

FIG. 14 is a schematic diagram illustrating a laminate which has a positive electrode, a negative electrode, and in which the side of the negative electrode is sealed.

FIG. 15(A) is a schematic diagram illustrating an air battery before liquid injection according to an embodiment of the invention, and FIG. 15(B) is a schematic diagram illustrating the back side of the air battery of FIG. 15(A).

FIG. 16 is a cross-sectional view schematically illustrating a part of an air battery after liquid injection according to an embodiment of the invention.

### DESCRIPTION OF EMBODIMENTS

Hereinafter, preferred embodiments of an aluminum air battery of the invention are described with reference to the drawings. However, the invention is not limited to the embodiments given below.

(Aluminum Air Battery)

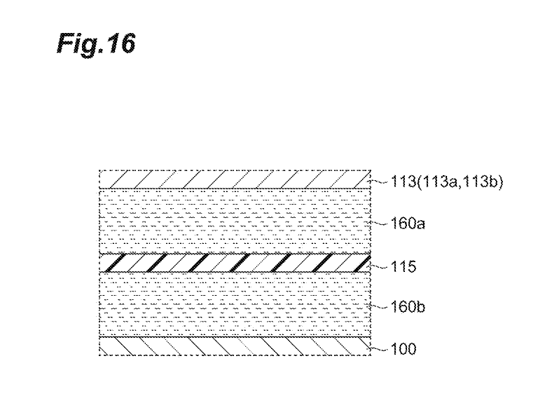

The air battery of the present embodiment comprises a positive electrode (113, 113a, 113b) having a positive electrode catalyst, a negative electrode 100 using an aluminum alloy, an air inlet 109, and an electrolyte solution (160a, 160b). Further, the air battery of the present embodiment comprises an anion-exchange membrane 115 arranged between the positive electrode and the negative electrode. The anion-exchange membrane 115 separates the electrolyte solution 160a in the side of the positive electrode from the electrolyte solution 160b in the side of the negative electrode (FIG. 16).

According to the present embodiment, the electrolyte solution in the side of the positive electrode and the electrolyte solution in the side of the negative electrode are not mixed with each other. For such a reason, it is possible to adjust freely each of the hydrogen ion (H⁺) concentration of the electrolyte solution in the side of the positive electrode and the hydrogen ion concentration of the electrolyte solution in the side of the negative electrode. In other words, for a case in which the electrolyte solution is an alkaline aqueous solution, it is possible to adjust the hydroxide ion (OH⁻) concentration of the alkaline aqueous solution in the side of the negative electrode to be lower than the hydroxide ion concentration of the alkaline aqueous solution in the side of the positive electrode. By that, self-corrosion of the aluminum alloy in the negative electrode can be easily suppressed.

The air battery of the present embodiment is preferably stored in an outer casing member. Examples of the material of the outer casing member include a resin such as polystyrene, polyethylene, polypropylene, polyvinyl chloride, and ABS, or a metal which does not react with a negative electrode, a positive electrode, and an electrolyte solution.

[Anion-Exchange Membrane]

The anion-exchange membrane preferably has an anion-exchange capacity of 0.5 to 3.0 milliequivalents/g; thereby, hydroxide ions contained in an alkaline aqueous solution can smoothly move through the anion-exchange membrane.

An anion-exchange resin constituting the anion-exchange membrane is, although not specifically restricted, preferably an anion-exchange resin selected from the group consisting of polysulfone (PS), polyether sulfone (PES), polyphenyl sulfone (PPS), polyvinylidene fluoride (PVdF), polyimide (PI), and a mixture thereof. From the viewpoint of having strength which does not allow breakage during handling, the anion-exchange membrane constituted with those resins is preferable.

Further, the anion-exchange resin constituting the anion-exchange membrane may also be an anion-exchange resin selected from the group consisting of styrene, divinylbenzene, a mixture thereof, and a copolymer thereof. From the viewpoint of resistance to an alkaline aqueous solution, the anion-exchange membrane constituted with those resins is preferable.

The anion-exchange membrane may also contain a reinforcing material for enhancing the membrane strength. The material of the reinforcing material is preferably a resin such as polystyrene, polyethylene, polypropylene, polyvinyl chloride, and ABS, or a metal which does not react with a negative electrode, a positive electrode, an electrolyte solution and the anion-exchange membrane.

[Air Inlet]

While the positive electrode catalyst can normally function as an air inlet, an air inlet other than the positive electrode catalyst may be formed in the outer casing member (for example, the positive electrode cover).

[Electrolyte Solution]

The electrolyte solution used for the present embodiment contains at least a solvent and an electrolyte, and is in contact with at least the positive electrode or negative electrode.

The electrolyte solution used for the present embodiment contains an aqueous solvent. Examples of the aqueous solvent which may be normally used include water.

Preferred examples of the electrolyte for the aqueous solvent include hydroxide of at least one selected from the group consisting of potassium, sodium, lithium, barium, and magnesium (KOH, NaOH, LiOH, Ba(OH)₂, and Mg(OH)₂). By using those electrolytes, hydroxide ions can be smoothly released from the electrolytes.

Concentration of the electrolyte contained in an aqueous solvent is preferably 1 to 99% by weight, more preferably 5 to 60% by weight, and still more preferably 5 to 40% by weight.

The hydrogen ion concentration of the electrolyte solution in the side of the positive electrode is preferably different from the hydrogen ion concentration of the electrolyte solution in the side of the negative electrode. pH of the electrolyte solution in the side of the positive electrode is 12.5 to 14, for example. pH of the electrolyte solution in the side of the negative electrode is 12 to 14, for example. Herein, pH of the electrolyte solution in the side of the negative electrode is preferably lower than pH of the electrolyte solution in the side of the positive electrode. A hydroxide ion concentration of the electrolyte solution in the side of the negative electrode is preferably 0.1 to 2 M (mole/liter), and more preferably 0.5 to 1.5 M. A hydroxide ion concentration of the electrolyte solution in the side of the positive electrode is preferably 1 to 7 M, and more preferably 2 to 7 M. Herein, the hydroxide ion concentration of the electrolyte solution in the side of the negative electrode is preferably lower than the concentration of hydroxide ions in the side of the positive electrode.

The hydrogen ion concentration of the electrolyte solution being in contact with the aluminum alloy in the negative electrode is preferably higher than the hydrogen ion concentration of the electrolyte solution being in contact with the positive electrode. That is, pH of the electrolyte solution in the side of the negative electrode is preferably lower than pH of the electrolyte solution in the side of the positive electrode. When the electrolyte solution being in contact with the aluminum alloy in the negative electrode is weakly alkaline, corrosion rate of the negative electrode is slower compared to a case in which the electrolyte solution is strongly alkaline.

Meanwhile, the hydrogen ion concentration of the electrolyte solution being in contact with the positive electrode is preferably lower than the hydrogen ion concentration of the electrolyte solution being in contact with the negative electrode. That is, pH of the electrolyte solution in the side of the positive electrode is preferably higher than pH of the electrolyte solution in the side of the negative electrode. When the electrolyte solution being in contact with the positive electrode is strongly alkaline, activity of the positive electrode is further enhanced compared to a case in which the electrolyte solution is weakly alkaline.

[Circulation]

The electrolyte solution may circulate between the inside and outside of an air battery via a nozzle attached with a closing cap that is formed on the air battery. With circulating electrolyte solution, it becomes possible to draw a poisonous product of the electrolyte solution to the outside of the battery for removal.

[Positive Electrode]

In general, the positive electrode having a positive electrode catalyst which is used for the present embodiment preferably contains, in addition to the positive electrode catalyst, a conductive material and a binder for attaching them to the positive electrode current collector. In addition, an oxygen diffusion membrane may be further compressed onto the positive electrode.

Preferred embodiment of the positive electrode catalyst is a material which can reduce oxygen, and it includes manganese dioxide and platinum.

The positive electrode catalyst may contain a Perovskite type composite oxide represented by ABO₃. In the A site, it is preferable that at least two elements selected from the group consisting of La, Sr and Ca be included. In the B site, it is preferable that at least one element selected from the group consisting of Mn, Fe, Cr and Co be included.

The positive electrode catalyst may also be an oxide containing at least one metal selected from the group consisting of iridium, titanium, tantalum, niobium, tungsten, and zirconium.

<Conductive Material>

Examples of the conductive material include carbonaceous materials such as acetylene black and Ketjen Black.

<Binder>

It is sufficient that as the binder, one which is not dissolved in an electrolyte solution to be used is used. Specific examples of the binder include fluororesins such as polytetrafluoroethylene (PTFE), tetrafluoroethylene.perfluoroalkyl vinyl ether copolymers, tetrafluoroethylene.hexafluoropropylene copolymers, tetrafluoroethylene.ethylene copolymers, polyvinylidene fluoride, polychlorotrifluoroethylene and chlorotrifluoroethylene.ethylene copolymers.

<Positive Electrode Current Collector>

It is sufficient that the positive electrode current collector is a conducting material. Specific examples of the positive electrode current collector include at least one metal selected from the group consisting of nickel, chrome, iron, copper, silver, and titanium. Preferred examples of the positive electrode current collector include nickel and stainless steel. Examples of the shape of the positive electrode current collector include a metal plate shape, a mesh shape, and a porous plate shape. Preferably, the positive electrode current collector is a mesh or a porous plate.

<Oxygen Diffusion Membrane>

It is sufficient that the oxygen diffusion membrane is a porous material. Specific examples of the oxygen diffusion membrane include fluororesins such as polytetrafluoroethylene (PTFE), tetrafluoroethylene.perfluoroalkyl vinyl ether copolymers, tetrafluoroethylene.hexafluoropropylene copolymers, tetrafluoroethylene.ethylene copolymers, polyvinylidene fluoride, polychlorotrifluoroethylene and chlorotrifluoroethylene.ethylene copolymers.

It is also preferable that the oxygen diffusion membrane have water repellency.

[Negative Electrode Using Aluminum Alloy]

The “aluminum alloy” used for the negative electrode in the present embodiment implies highly pure aluminum which contains a trace amount of elements other than aluminum as described below. The aluminum alloy preferably has a magnesium content of 0.0001% by weight to 8% by weight. From the viewpoint of easy preparation of the aluminum alloy, the aluminum alloy preferably has a magnesium content of 1% by weight to 8% by weight, more preferably 0.01% by weight to 4% by weight, and particularly preferably 2% by weight to 4% by weight. The magnesium content within the numerical range described above makes it possible to further suppress self-discharge (corrosion) of the negative electrode in an alkaline aqueous solution.

The aluminum alloy preferably satisfies one or more of the conditions (A) or (B) described below.

Condition (A): The aluminum alloy has an iron content of 0.0001% by weight to 0.03% by weight or less, and preferably 0.0001% by weight to 0.005% by weight; thereby, self-discharge (corrosion) of the negative electrode in an alkaline aqueous solution can be further suppressed.

Condition (B): The aluminum alloy has a silicon content of 0.0001% by weight to 0.02% by weight, and preferably 0.0005% by weight to 0.005% by weight; thereby, self-discharge (corrosion) of the negative electrode in an alkaline aqueous solution can be further suppressed.

Of among the elements contained in the aluminum alloy, a content of each element other than Al, Mg, Si, and Fe is preferably 0.005% by weight or less, more preferably 0.002% by weight or less, and particularly preferably 0.001% by weight or less with respect to the entire aluminum alloy; thereby, self-discharge (corrosion) of the negative electrode in an alkaline aqueous solution can be further suppressed. Meanwhile, examples of the “each element other than Al, Mg, Si, and Fe” include Cu, Ti, Mn, Ga, Ni, V, or Zn.

A total amount of the metal other than Al and Mg of among the elements contained in the aluminum alloy is preferably 0.1% by weight or less, more preferably 0.02% by weight or less, and particularly preferably 0.015% by weight or less with respect to the entire aluminum alloy; thereby, self-discharge (corrosion) of the negative electrode in an alkaline aqueous solution can be further suppressed. Meanwhile, examples of the “metal other than Al and Mg” include Si, Fe, Cu, Ti, Mn, Ga, Ni, V, or Zn.

The aluminum alloy preferably has a copper content of 0.002% by weight or less; thereby, self-discharge (corrosion) of the negative electrode in an alkaline aqueous solution can be further suppressed.

The aluminum alloy may contain an intermetallic compound within the alloy matrix thereof. Examples of the intermetallic compound include Al₃Mg, Mg₂Si, and Al—Fe alloys. Of among the particles of the intermetallic compound observed in the surface of the aluminum alloy, density of the particles which have particle size (cross sectional area of particle) of less than 100 μm² is preferably 1000 particles/mm² or less, and more preferably 500 particles/mm² or less. Density of coarse particles which have particle size of 100 μm² or more is preferably 10 particles/mm² or less. Meanwhile, the “density of particles” indicates number of the intermetallic compound particles that are present in a unit area in the surface of the aluminum alloy. The density of particles can be measured by observation of an aluminum surface using an optical microscope.

When the density of particles in the compound having particle size of less than 100 μm² is 1000 particles/mm² or less, corrosion resistance of the aluminum alloy is further increased. When the density of coarse particles which have particle size of 100 μm² or more is 10 particles/mm² or less, self-discharge (corrosion) of the negative electrode in an alkaline aqueous solution can be further suppressed.

Further, area ratio of the intermetallic compound particles to a unit area of the aluminum alloy is preferably 0.005 or less, more preferably 0.002 or less, and particularly preferably 0.001 or less. The area ratio represents the ratio of integrated area of the size (cross sectional area) of individual intermetallic compound particle that is observed in a unit area in the surface of the aluminum alloy, based on the unit area of the aluminum alloy. When the area ratio is the same or less than upper limit, corrosion resistance of the aluminum alloy is further increased.

It is preferable that a lead wire for current takeout be connected to the negative electrode consisting of the aluminum alloy. By connecting of the lead wire, the discharge current can be efficiently taken out from the negative electrode.

(Method for Preparing Aluminum Alloy)

For the method for preparing an aluminum alloy, highly pure aluminum (purity: 99.999% by weight or more) is melt at approximately 680 to 800° C., for example. By adding a prescribed amount of magnesium (purity: 99.99% by weight or more) to the molten aluminum, alloy melt is obtained. By performing a treatment for removing hydrogen gas or non-metallic inclusions, which are included in the alloy melt, for purification (for example, vacuum treatment of alloy melt), the aluminum alloy is obtained. The vacuum treatment is generally carried out under the condition including vacuum level of 0.1 to 100 Pa for about 1 to 10 hours at approximately 700 to 800° C. Examples of the treatment for purifying an alloy include a treatment of blowing flux, inert gas or chlorine gas into molten alloy. The molten alloy purified by vacuum treatment or the like is generally subjected to casting in a mold to obtain ingots. Examples of the mold which may be used include an iron mold or a graphite mold heated to 50 to 200 ° C. The casting is generally performed by adding molten alloy at 680 to 800° C. to a mold.

Subsequently, the ingots are subjected to a solid solution treatment. For the solid solution treatment, the ingots are heated from a room temperature to approximately 430° C. at rate of about 50° C./hour and maintained for approximately 10 hours. Subsequently, the ingots are heated to approximately 500° C. at rate of about 50° C./hour and maintained for approximately 10 hours. Subsequently, the ingots are cooled from approximately 500° C. to approximately 200° C. at rate of about 300° C./hour.

The ingots after the solid solution treatment may be used by itself as a battery member after cutting machining. It is also possible that, a plate member or a section member may be formed by performing rolling processing, extrusion processing, or forging processing of ingot. The plate member or section member consisting of the aluminum alloy can be easily used as a battery member and has a high 0.2% load bearing property.

For rolling processing of ingots, by performing hot rolling and cold rolling, for example, ingots are prepared as a plate member. The hot rolling is performed repeatedly with one pass processing rate of 2 to 20% while heating the ingots to 350 to 450° C. until the desired thickness of the ingots is obtained.

In general, an annealing treatment of the ingots is performed after hot rolling but before cold rolling. For the annealing treatment, the plate member obtained by hot rolling may be heated to the temperature of 350 to 450° C. and cooled naturally immediately after temperature increase, or the heated plate member may be maintained for about 1 to 5 hours and cooled naturally. According to the treatment, the material is softened, and as a result, the ingots in a state suitable for cold rolling are obtained.

After adjusting the temperature of ingots to the temperature which is lower than recrystallization temperature of the aluminum alloy, the cold rolling is performed repeatedly with one pass processing rate of 1 to 10% until the desired thickness of the ingots is obtained. Meanwhile, the temperature which is lower than recrystallization temperature of the aluminum alloy is generally from room temperature to 80° C. or less. The plate member consisting of the aluminum alloy that is obtained by cold rolling is thin and has 0.2% load bearing property of 150 N/mm² or more.

[Oxygen Selective Permeable Membrane]

It is preferable that an oxygen selective permeable membrane be mounted on the air inlet. In an air battery using an alkaline aqueous solution as an electrolyte solution, according to introduction of carbon dioxide in the air together with oxygen via the air inlet, clogging of the positive electrode catalyst or neutralization of the alkaline aqueous solution is caused, yielding deteriorated characteristics of the air battery.

By mounting an oxygen selective permeable membrane, introduction of carbon dioxide can be suppressed, and thus the above problems can be solved.

The electrolyte solution containing the dissolved oxygen has a contact angle with the surface of the oxygen selective permeable membrane of preferably 90° or more. The contact angle of 90° or more makes it possible to reduce liquid leakage from the oxygen selective permeable membrane.

Examples of the oxygen selective permeable membrane exhibiting contact angle of 90° or more include a commercially available silicone membrane.

Further, from the viewpoint of preventing liquid leakage from an oxygen inlet, the contact angle is preferably 150° or more. The contact angle of 150° or more makes it possible to further reduce liquid leakage from the oxygen selective permeable membrane.

Further, examples of the oxygen selective permeable membrane include the silicone membrane and a membrane made of alkyne polymer having one or more aromatic groups. By using those membranes, carbon dioxide is selectively removed from the air, and thus only oxygen can be easily supplied to the positive electrode.

When carbon dioxide is selectively removed from the air, generation of potassium hydrogen carbonate (KHCO₃) or potassium carbonate (K₂CO₃) due to a reaction between KOH that is an electrolyte in the electrolyte solution and carbon dioxide can be prevented, for example. Accordingly, battery performance deterioration can be suppressed.

Further, when carbon dioxide is selectively removed from the air, precipitation of potassium hydrogen carbonate (KHCO₃) or potassium carbonate (K₂CO₃) on a surface of the positive electrode catalyst can be prevented. Accordingly, battery performance deterioration can be suppressed.

The aromatic group included in the alkyne polymer membrane is preferably a group selected from the group consisting of a phenyl group, a substituted phenyl group, a naphthalyl group, an anthracenyl group, a pyrenyl group, a perylenyl group, a pyridinyl group, a pyrrolyl groups, a thiophenyl group, and a furyl group, or a substituted aromatic group in which a part of hydrogen atoms in the group described above is substituted. When the aromatic group is one of the groups described above, the oxygen/carbon dioxide selective permeability is further improved. The aromatic group is more preferably a phenyl group or a substituted phenyl group.

Oxygen selective coefficient (PO₂) of the oxygen selective permeable membrane is preferably 400×10⁻¹⁰ cm³·cm/cm²·s·cmHg (=400 Barrer) or more.

PO₂ of 400×10⁻¹⁰ cm³·cm/cm²·s·cmHg or more enables oxygen to permeate the selective permeable membrane easily.

Examples of the oxygen selective permeable membrane exhibiting the oxygen selective coefficient described above include a commercially available silicone membrane. Meanwhile, PO₂ is a value measured at 23° C., 60% humidity by using gas with oxygen/nitrogen volume ratio of 20/80 (v/v) and a gas permeability meter (GTR-30X, manufactured by GTR Tec Corp.).

PO₂/PCO₂ is preferably 0.15 or more. With such oxygen selective permeable membrane, permeation of carbon dioxide is easily suppressed.

Examples of the oxygen selective permeable membrane exhibiting the oxygen/carbon dioxide selective permeability described above include a commercially available silicone membrane. Meanwhile, PCO₂ is a value measured at 23° C., 60% humidity by using pure carbon dioxide g as and a gas permeability meter (GTR-30X, manufactured by GTR Tec Corp.).

### EXAMPLES

Hereinafter, the invention will be described in more detail by way of Examples, but the invention is not limited to those Examples.

(Fabrication of Positive Electrode Having Positive Electrode Catalyst)

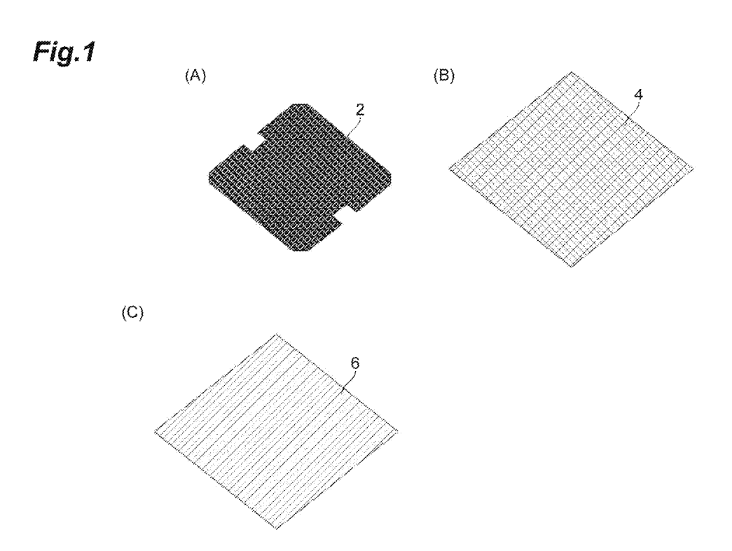

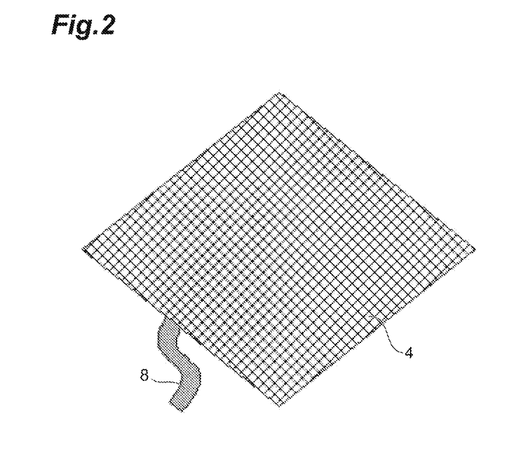

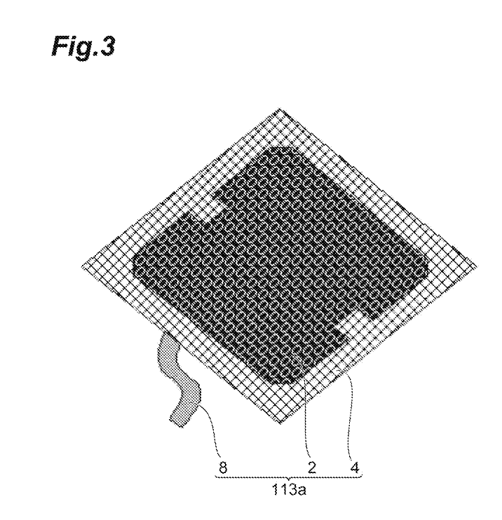

A mixture containing acetylene black as a conductive material, manganese dioxide as a positive electrode catalyst for promoting reduction of oxygen, and powdery PTFE as a binder was molded to form a positive electrode material. The weight ratio of acetylene black:manganese dioxide:PTFE in the mixture was adjusted to 10:10:1. Dimension of the positive electrode material was 40 mm long×40 mm wide×0.3 mm thick. The positive electrode material was cut as illustrated in FIG. 1(A). In addition, a nickel ribbon terminal 8 for external connection (50 mm long×3 mm wide×0.2 mm thick) was connected (FIG. 2) to an end part of the stainless steel mesh positive electrode current collector 4 for discharging (50 mm long×50 mm wide×0.1 mm thick, FIG. 1(B)). Then, the positive electrode material 2 of FIG. 1(A) was brought into contact with surface of the positive electrode current collector 4 of FIG. 2 to obtain the positive electrode 113a (FIG. 3).

(Installation of Oxygen Diffusion Membrane on Positive Electrode)

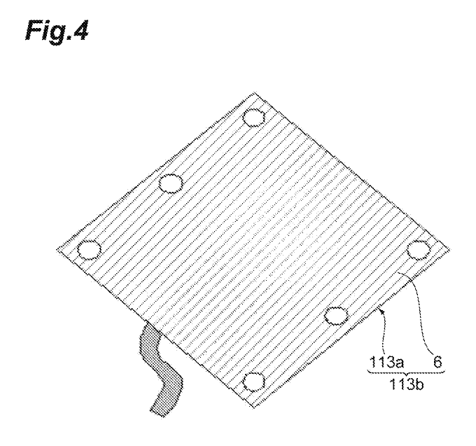

On the surface of the positive electrode material 2 of the positive electrode 113a, a water-repellent PTFE sheet 6 (50 mm long×50 mm wide×0.1 mm thick, FIG. 1(C)) as an oxygen diffusion membrane was applied and pressed; thereby, the positive electrode 113b attached with an oxygen diffusion membrane was obtained (FIG. 4). In addition, as illustrated in FIG. 4, holes of φ4.5 mm were formed at six spots on the positive electrode 113b.

(Attachment of Oxygen Selective Permeable Membrane on Positive Electrode 113b Attached with Oxygen Diffusion Membrane)

On the surface of the oxygen diffusion membrane of the positive electrode 113b attached with an oxygen diffusion membrane, a silicone membrane, which is an oxygen selective permeable membrane, was attached to obtain the positive electrode 113 attached with an oxygen selective permeable membrane. Holes of φ4.5 mm were formed at six spots on the attached silicone membrane (same spots as those illustrated in FIG. 4). As a silicone membrane, Silicone Film (product name) manufactured by As One Corp. was used. The contact angle of the electrolyte solution relative to the silicone membrane was 105°. Dimension of the silicone membrane was 50 mm long×50 mm wide×0.1 mm thick.

(Fabrication of Aluminum Alloy Plate)

Aluminum alloy plates of the following samples 1 to 11 were fabricated as follows. That is, as an aluminum alloy plate before processing, a rectangular shape plate with length (l)×width (w)×thickness (t) was prepared. Without changing the width (w) of the aluminum alloy plate before processing, it was rolled in the thickness (t) direction to fabricate each aluminum alloy plate as a negative electrode member of the air battery.

Further, the physical property determination of the aluminum alloy plate was performed according to the following method.

(Component Analysis of Aluminum Alloy Plate)

By using an optical emission spectrophotometer (type: ARL-4460, manufactured by Thermo Fisher Scientific Corp.), content of Mg, Si, Fe, Cu, Ti, Mn, Ga, Ni, V, and Zn in the aluminum alloy plate was measured.

(Processing Rate of Rolling)

Calculation was made based on the following formula (1) from the cross sectional area (S₀) of the aluminum alloy plate before processing, i.e., product of the width w and thickness t before processing, and the cross sectional area (S) of the aluminum alloy plate after processing, i.e., product of the width w and thickness t after processing.

Processing rate (%)=(S₀−S)/S₀×100 (1)

(Particle Size, Particle Density, and Area of Occupancy of Intermetallic Compound in Aluminum Alloy)

After mirror grinding of the surface of the aluminum alloy, the aluminum alloy was impregnated for 60 seconds in 1% by weight aqueous solution of sodium hydroxide at liquid temperature of 20° C. for etching followed by water washing. Photographic image of the surface of the aluminum alloy after water washing was taken by using an optical microscope. From the photographic image of the surface of the aluminum alloy taken by using an optical microscope with 200× magnification ratio, the particle size, particle density (number per unit area), and area of occupancy of the intermetallic compound particles were measured. Meanwhile, particles with cross sectional area of less than 0.1 μm², that are difficult to observe from the optical microscopic image, were not counted.

(Strength of Aluminum Alloy (0.2% Load Bearing Property))

Strength of the JIS No. 5 test specimen consisting of the aluminum alloy was measured according to 0.2% offset method using INSTRON 8802. The test speed for the measurement was 20 mm/minute.

(Corrosion Resistance of Aluminum Alloy)

The test specimen (40 mm long×40 mm wide×0.5 mm thick) was impregnated in sulfuric acid (concentration; 1 mol/L, and temperature of 80° C.). Two hours, eight hours, or twenty-four hours after the impregnation, Al and Mg eluted from the test specimen were measured. The eluted Al and Mg were quantified by inductively coupled plasma atomic emission spectroscopy (ICP-AES).

(Production of Aluminum Alloy Sample 1)

Highly pure aluminum (purity: 99.999% by weight or more) was melted at 750° C. to obtain molten aluminum. Next, the molten aluminum was kept for 2 hours under condition including temperature of 750° C. and vacuum degree of 50 Pa for cleaning. The molten aluminum after the cleaning was casted in a cast iron mold (22 mm×150 mm×200 mm) at 150° C. to obtain an ingot.

Subsequently, the ingot was subjected to a solid solution treatment according to the following condition. The ingot was heated from room temperature (25° C.) to 430° C. at rate of 50° C./hour and maintained for 10 hours at 430° C. Subsequently, the ingot was heated to 500° C. at rate of 50° C./hour and maintained for 10 hours at 500° C. After that, the ingot was cooled from 500° C. to 200° C. at rate of 300° C./hour.

Both surfaces of the ingot obtained after a solid solution treatment were treated by 2 mm face milling followed by hot rolling to obtain an aluminum plate. The hot rolling was performed by heating the ingot in an atmosphere of 350° C. to 450° C. with processing rate of 83% until the thickness of the ingot is changed from 18 mm to 3 mm. Next, the ingot (aluminum plate) after hot rolling was subjected to an annealing treatment according to a method including heating to the temperature of 370° C., maintaining for 1 hour after temperature increase, and cooling naturally. Next, the aluminum plate was subjected to cold rolling to obtain a rolled plate. The cold rolling was performed by adjusting the temperature of the aluminum plate to 50° C. or lower with processing rate of 67% until the thickness of the aluminum plate is changed from 3 mm to 1 mm. The obtained rolled plate is referred to as Sample 1.

Results of measuring the components contained in Sample 1 are described in Table 1.

(Production of Aluminum Alloy Sample 2)

Highly pure aluminum (purity: 99.999% by weight or more) was melted at 750° C. and magnesium (purity: 99.99% by weight or more) was added to the molten aluminum to obtain a molten aluminum alloy having Mg content of 2.5% by weight. Next, the molten alloy was kept for 2 hours under condition including temperature of 750° C. and vacuum degree of 50 Pa for cleaning. The molten alloy was casted in a cast iron mold (22 mm×150 mm×200 mm) at 150° C. to obtain an ingot.

Subsequently, the ingot was subjected to a solid solution treatment according to the following condition. The ingot was heated from room temperature (25° C.) to 430° C. at rate of 50° C./hour and maintained for 10 hours at 430° C. Subsequently, the ingot was heated to 500° C. at rate of 50° C./hour and maintained for 10 hours at 500° C. After that, the ingot was cooled from 500° C. to 200° C. at rate of 300° C./hour.

Both surfaces of the ingot obtained after a solid solution treatment were treated by 2 mm face milling followed by hot rolling to obtain an aluminum alloy plate. The hot rolling was performed by heating the ingot to 350° C. to 450° C. with processing rate of 83% until the thickness of the ingot is changed from 18 mm to 3 mm. Next, the ingot (aluminum alloy plate) after hot rolling was subjected to an annealing treatment according to a method including heating to the temperature of 370° C., maintaining for 1 hour after temperature increase, and cooling naturally. Next, the aluminum alloy plate was subjected to cold rolling to obtain a rolled plate. The cold rolling was performed by adjusting the temperature of the aluminum plate to 50° C. or lower with processing rate of 67% until the thickness of the aluminum alloy plate is changed from 3 mm to 1 mm. The obtained rolled plate is referred to as Sample 2.

Results of measuring the components contained in Sample 2 are described in Table 1.

(Preparation of Aluminum Alloy Sample 3)

Sample 3 was prepared by carrying out the same procedures as those of Sample 2 except that the mixing is made to have the Mg content of 3.8% by weight in the aluminum alloy.

Results of measuring the components contained in Sample 3 are described in Table 1.

(Preparation of Aluminum Alloy Sample 4)

Sample 4 was prepared by carrying out the same procedures as those of Sample 2 except that the mixing is made to have the Mg content of 5.0% by weight in the aluminum alloy.

(Preparation of Aluminum Alloy Sample 5)

Sample 5 was prepared by carrying out the same procedures as those of Sample 2 except that the mixing is made to have the Mg content of 7.0% by weight in the aluminum alloy.

(Preparation of Aluminum Alloy Sample 6)

Sample 6 was prepared by carrying out the same procedures as those of Sample 2 except that the mixing is made to have the Mg content of 10.0% by weight in the aluminum alloy.

(Preparation of Aluminum Alloy Sample 7)

Sample 7 was prepared by carrying out the same procedures as those of Sample 2 except that the mixing is made to have the Mg content of 12.0% by weight in the aluminum alloy.

(Preparation of Aluminum Alloy Sample 8)

Sample 8 was prepared by carrying out the same procedures as those of Sample 1 except that aluminum (purity: 99.8% by weight) is used instead of highly pure aluminum (purity: 99.999% by weight).

Results of measuring the components contained in Sample 8 are described in Table 1.

(Preparation of Aluminum Alloy Sample 9)

Sample 9 was prepared by carrying out the same procedures as those of Sample 2 except that aluminum (purity: 99.8% by weight) is used instead of highly pure aluminum (purity: 99.999% by weight).

Results of measuring the components contained in Sample 9 are described in Table 1.

(Preparation of Aluminum Alloy Sample 10)

Sample 10 was prepared by carrying out the same procedures as those of Sample 2 except that aluminum (purity: 99.8% by weight) is used instead of highly pure aluminum (purity: 99.999% by weight) and the Mg content in the aluminum alloy is adjusted to 3.7% by weight by adding Mg to molten aluminum.

Results of measuring the components contained in Sample 10 are described in Table 1.

(Preparation of Aluminum Alloy Sample 11)

Sample 11 was prepared by carrying out the same procedures as those of Sample 2 except that the Cu content in the aluminum alloy is adjusted to 0.5% by weight by adding Cu (purity: 99.99% by weight) to the molten aluminum instead of Mg.

Results of measuring the components contained in Sample 11 are described in Table 1.

TABLE 1

| | Aluminum | | | | | | |
|---|---|---|---|---|---|---|---|
| | as raw | Chemical components (wt %) | | | | | |
| | material | Mg | Si | Fe | Cu | Ti | Mn |
| Sample 1 | High purity | 0.00004 | 0.0002 | 0.00008 | 0.00018 | ≦0.00002 | ≦0.00001 |
| Sample 2 | High purity | 2.5 | 0.003 | 0.0002 | ≦0.001 | ≦0.001 | ≦0.001 |
| Sample 3 | High purity | 3.8 | 0.005 | 0.0003 | ≦0.001 | ≦0.001 | ≦0.001 |
| Sample 8 | Low purity | ≦0.001 | 0.043 | 0.075 | ≦0.001 | 0.005 | ≦0.001 |
| Sample 9 | Low purity | 2.5 | 0.044 | 0.075 | ≦0.001 | 0.005 | ≦0.001 |
| Sample 10 | Low purity | 3.7 | 0.044 | 0.072 | ≦0.001 | 0.006 | ≦0.001 |
| Sample 11 | High purity | ≦0.0001 | 0.0002 | 0.00012 | 0.51 | ≦0.0001 | 0.00003 |
| | | | | | | | Total |
| | | Aluminum | | | | | excluding |
| | | as raw | Chemical components (wt %) | | | | Al + Mg |
| | | material | Ga | Ni | V | Zn | (wt %) |
| | Sample 1 | High purity | ≦0.00005 | ≦0.00003 | ≦0.00002 | ≦0.0001 | ≦0.00071 |
| | Sample 2 | High purity | ≦0.001 | ≦0.001 | ≦0.001 | ≦0.001 | ≦0.011 |
| | Sample 3 | High purity | ≦0.001 | ≦0.001 | ≦0.001 | ≦0.001 | ≦0.013 |
| | Sample 8 | Low purity | 0.012 | 0.005 | 0.007 | 0.002 | ≧0.148 |
| | Sample 9 | Low purity | 0.011 | 0.005 | 0.007 | 0.002 | ≧0.149 |
| | Sample 10 | Low purity | 0.011 | 0.005 | 0.008 | 0.002 | ≧0.148 |
| | Sample 11 | High purity | ≦0.0001 | ≦0.0001 | ≦0.0001 | ≦0.0001 | ≧0.511 |

Among the contents described in Table 1, in the aluminum alloy, content of Mg is preferably 0.00001% by weight to 8% by weight, more preferably 0.00001% by weight to 4% by weight, and still more preferably 0.01% by weight to 4% by weight. Content of Si is preferably 0.0001% by weight to 0.05% by weight, and more preferably 0.0001% by weight to 0.01% by weight. Content of Fe is preferably 0.00005% by weight to 0.1% by weight, and more preferably 0.00005% by weight to 0.005% by weight. Content of Cu is preferably 0.0001% by weight to 0.5% by weight, and more preferably 0.0001% by weight to 0.005% by weight. Content of Ti is preferably 0.000001% by weight to 0.01% by weight, and more preferably 0.00001% by weight to 0.001% by weight. Content of Mn is preferably 0.000001% by weight to 0.03% by weight, and more preferably 0.000001% by weight to 0.001% by weight. Content of Ga is preferably 0.000001% by weight to 0.03% by weight, and more preferably 0.00001% by weight to 0.001% by weight. Content of Ni is preferably 0.000001% by weight to 0.03% by weight, and more preferably 0.00001% by weight to 0.001% by weight. Content of V is preferably 0.000001% by weight to 0.03% by weight, and more preferably 0.00001% by weight to 0.001% by weight. Content of Zn is preferably 0.000001% by weight to 0.03% by weight, and more preferably 0.00001% by weight to 0.005% by weight.

(Preparation of Electrolyte Solution 1)

By mixing potassium hydroxide and pure water, 0.5 M aqueous KOH solution was prepared as the electrolyte solution 1.

(Preparation of Electrolyte Solution 2)

By mixing potassium hydroxide and pure water, 1.0 M aqueous KOH solution was prepared as the electrolyte solution 2.

(Preparation of Electrolyte Solution 3)

By mixing potassium hydroxide and pure water, 3.0 M aqueous KOH solution was prepared as the electrolyte solution 3.

(Preparation of Electrolyte Solution 4)

By mixing potassium hydroxide and pure water, 6.0 M aqueous KOH solution was prepared as the electrolyte solution 4.

(Preparation of Electrolyte Solution 5)

By mixing potassium hydroxide and pure water, 2.0 M aqueous KOH solution was prepared as the electrolyte solution 5.

(Preparation of Electrolyte Solution 6)

By mixing potassium hydroxide and pure water, 7.0 M aqueous KOH solution was prepared as the electrolyte solution 6.

(Fabrication of Anion-Exchange Membrane)

For fabrication of an anion-exchange membrane, the anion-exchange resin precursor 1 was synthesized first according to the method described below.

(Preparation of Anion-Exchange Resin Precursor 1)

Under nitrogen atmosphere, 54.06 g of polyether sulfone (manufactured by Aldrich Corp.) was dissolved in 1350 ml of 1,1,2,2-tetrachloroethane having been heated to 120° C. To the solution, a mixture of 597 ml (6.76 mol) of dimethoxyethane and 540 ml of 1,1,2,2-tetrachloroethane was slowly added for 30 minutes or more, and 246 ml (3.42 mol) of thionyl chloride was further added.

To the solution, tetrahydrofuran suspension (135 ml) containing 18.79 g (137.8 mmol) of zinc chloride was additionally added, which was followed by being stirred under heating at 58 to 60° C. for 5 days. As a result, a brown solution was obtained.

After cooling the reaction solution (brown solution) obtained by heating and stirring to room temperature, it was poured over 6 L methanol. The gray solid precipitated in methanol was filtered, and the filtrate was washed three times with methanol and dried overnight under reduced pressure. The obtained solid (75.18 g) was dissolved in 900 ml dichloromethane and the solution was poured over 6 L of acetone under stirring. The solid precipitated in acetone was filtered and the filtrate was washed with acetone and dried under reduced pressure to obtain 60.13 g of the anion-exchange resin precursor 1 as a gray solid.

(Anion-Exchange Membrane Precursor 2)

10 g of the anion-exchange resin precursor 1 were dissolved in 190 g of dimethoxy acetamide. The solution was applied on a glass plate and dried at 50° C. for 24 hours. The coating film was again dried under vacuum at 80° C. for 1 hour.

By dipping the glass plate in distilled water, the film was separated from the glass plate. By drying it under vacuum at 80° C. for 24 hours, the anion-exchange membrane precursor 2 with thickness of 30 μm was obtained.

(Anion-Exchange Membrane 1)

The anion-exchange membrane precursor 2 was cut to have a size of 100 mm×100 mm. After impregnating it in 45% by weight aqueous solution of trimethylamine for 48 hours, the precursor 2 was taken out of the aqueous trimethylamine solution and impregnated in 1 M aqueous KOH solution for 48 hours. After that, the membrane was taken out of the KOH solution and impregnated in 100 ml distilled water for 24 hours to obtain the anion-exchange membrane 1.

An anion-exchange capacity of the anion-exchange membrane 1 was 2.5 milliequivalents/g.

(Anion-Exchange Membrane 2)

As an anion-exchange membrane 2, commercially available AHA (manufactured by ASTOM Corp.), which is a styrene-divinylbenzene copolymer-based membrane, was used.

(Fabrication of Aluminum Air Battery)

An aluminum air battery using Samples 1 to 11 as a negative electrode is fabricated according to the following order, and performance of the battery is evaluated.

(Fabrication of Aluminum Air Battery 1-1)

<Fabrication of Negative Electrode for Aluminum Air Battery>

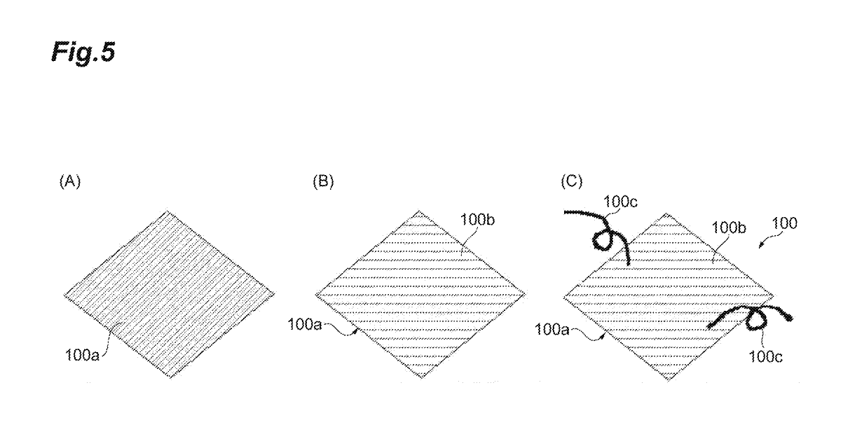

The aluminum alloy 100a of Sample 1, which has been prepared to have thickness of 1 mm by rolling processing, is cut to a size of 30 mm long×30 mm wide (FIG. 5(A)), and one surface is masked with the imide tape 100b (FIG. 5(B)). Portions of the masking (two spots with φ 2 mm) are removed and the vinyl chloride-coated aluminum lead wire 100c (purity: 99.5%, cross section of φ 0.25 mm×length of 100 mm, electrode voltage: −1.45 V) is attached to the portions by using a resistance welding machine (FIG. 5(C)). The aluminum exposed part of the welded area is masked with Araldite (epoxy resin-based adhesives) to obtain the negative electrode 100.

<Rubber Packing 112>

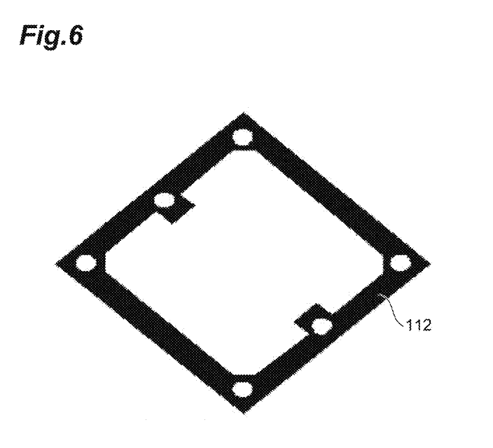

As illustrated in FIG. 6, the rubber packing 112 with holes and thickness of 0.5 mm is prepared.

<Rubber Packing 114>

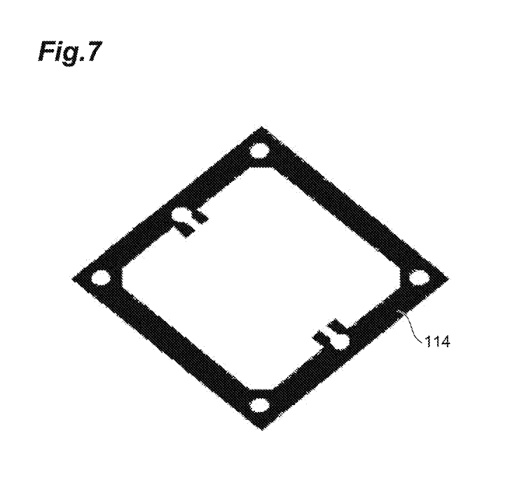

As illustrated in FIG. 7, the rubber packing 114 with holes and thickness of 0.5 mm is prepared.

<Negative Electrode Bath Frame>

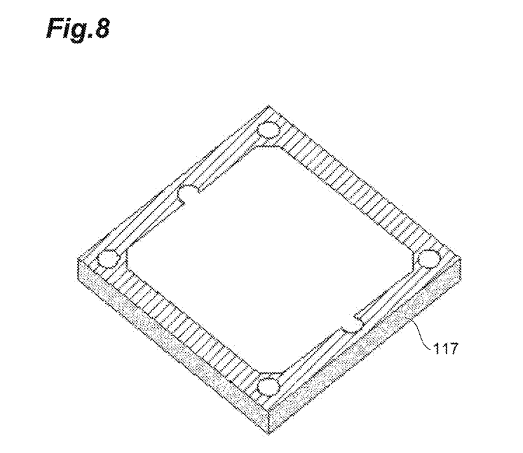

As illustrated in FIG. 8, the negative electrode bath frame 117 with holes and thickness of 10 mm is prepared. Material of the negative electrode bath frame 117 is stainless steel (JIS Standard SUS316).

<Negative Electrode Cover>

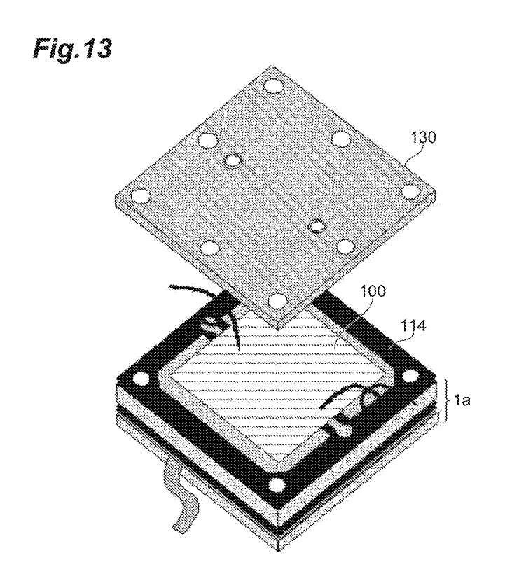

As illustrated in FIG. 13, the negative electrode cover 130 with holes and thickness of 2 mm is prepared. Material of the negative electrode cover 130 is stainless steel (JIS Standard SUS316).

<Anion-Exchange Membrane>

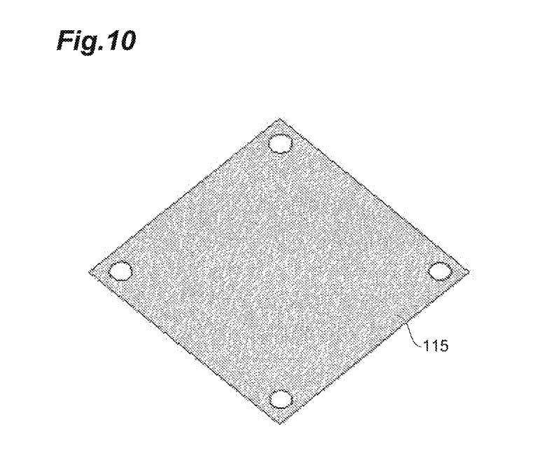

As an anion-exchange membrane, the anion-exchange membrane 1 is used. As illustrated in FIG. 10, the anion-exchange membrane 115 having holes of φ 4.5 mm formed at four corners is prepared.

<Assembly of Battery 1 Before Liquid Injection>

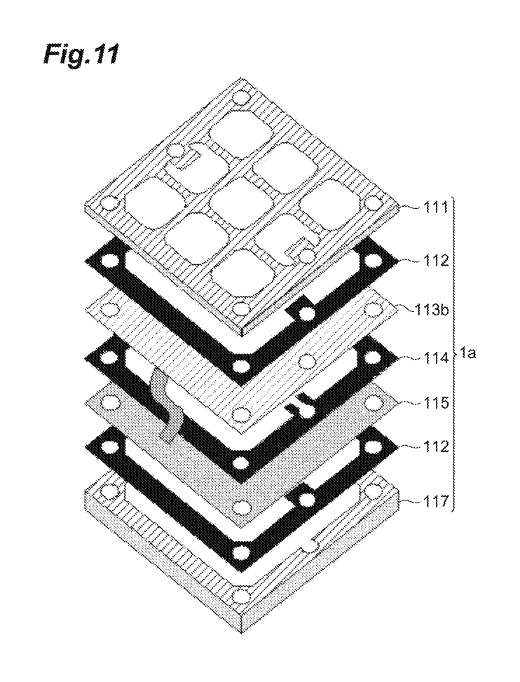

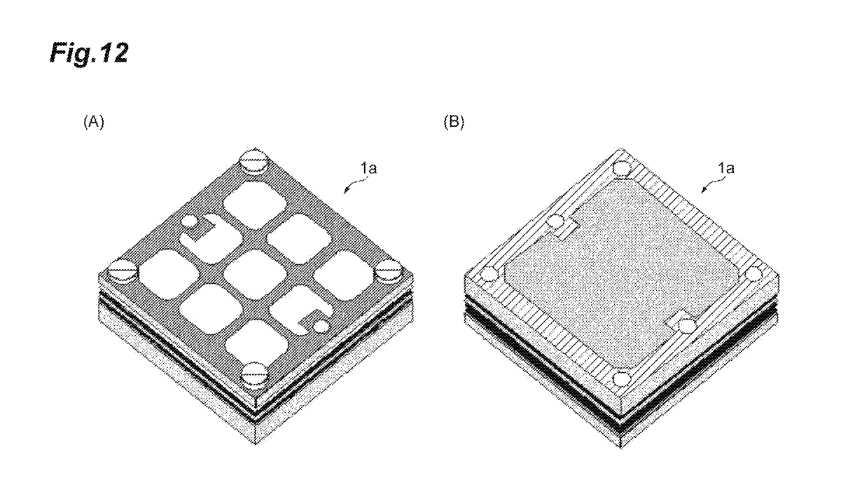

As illustrated in FIG. 11, the negative electrode bath frame 117, the rubber packing 112, the anion-exchange membrane 115, the rubber packing 114, the positive electrode 113b attached with oxygen diffusion membrane, the rubber packing 112, and the porous plate 111 (positive electrode cover) for pressing positive electrode catalyst are laminated in order. Four corners of them are fixed by insulating screws (for example, those made of PEEK (polyether ether ketone)) to fabricate a positive electrode side unit (laminate 1a) (FIG. 12(A)).

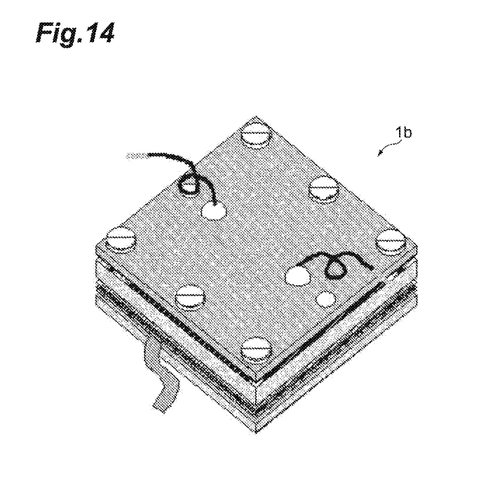

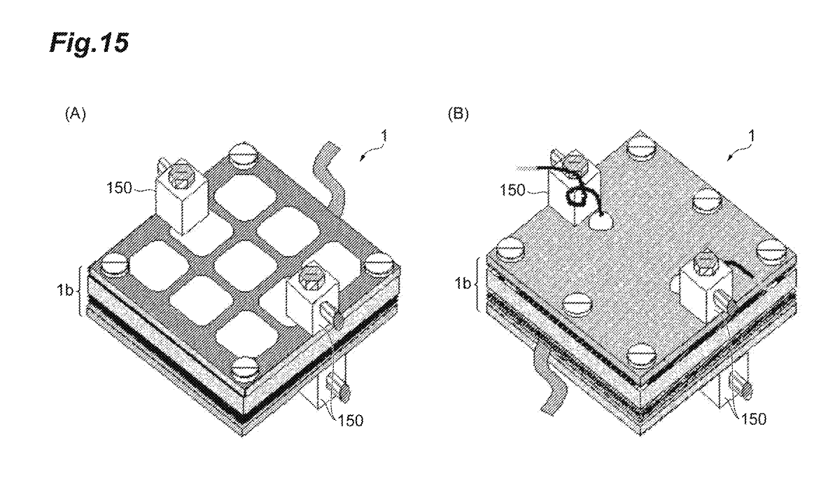

Subsequently, on a surface of the negative electrode bath frame 117 of the laminate la turned back (FIG. 12(B)), the lead-attached negative electrode 100, the rubber packing 114, and the negative electrode cover 130 are laminated in order (FIG. 13). Four corners of the laminate are fixed by insulating screws and the gap between the negative electrode lead wire and the negative electrode cover is sealed with Araldite (epoxy resin-based adhesives) (FIG. 14). On the sealed laminate 1b, the nozzles 150 attached with closing cap are added at four spots to assemble the battery 1 before liquid injection (FIGS. 15(A) and 15(B)).

(Assembly of Battery 2 to 11 Before Liquid Injection)

The battery 2 before liquid injection is assembled in the same manner as the battery 1 before liquid injection except that Sample 2 is used for the negative electrode. The battery 3 before liquid injection is assembled in the same manner as the battery 1 before liquid injection except that Sample 3 is used for the negative electrode. The battery 8 before liquid injection is assembled in the same manner as the battery 1 before liquid injection except that Sample 8 is used for the negative electrode. The battery 9 before liquid injection is assembled in the same manner as the battery 1 before liquid injection except that Sample 9 is used for the negative electrode. The battery 10 before liquid injection is assembled in the same manner as the battery 1 before liquid injection except that Sample 10 is used for the negative electrode. The battery 11 before liquid injection is assembled in the same manner as the battery 1 before liquid injection except that Sample 11 is used for the negative electrode.

(Assembly of Battery 21 Before Liquid Injection)

The battery 21 before liquid injection is assembled in the same manner as the battery 1 before liquid injection except that the positive electrode 113 attached with oxygen selective permeable membrane is used as a positive electrode instead of the positive electrode 113b attached with oxygen diffusion membrane.

(Assembly of Battery 22 to 31 Before Liquid Injection)

The batteries 22 to 31 before liquid injection are assembled in the same manner as the battery 21 before liquid injection except that Samples 2 to 11 are used for their negative electrodes.

(Assembly of Battery 41 Before Liquid Injection)

The battery 41 before liquid injection is assembled in the same manner as the battery 1 before liquid injection except that the anion-exchange membrane 1 is changed to a hydrophilic PTFE porous film.

(Assembly of Battery 42 to 51 Before Liquid Injection)

The battery 42 before liquid injection is assembled in the same manner as the battery 41 before liquid injection except that Sample 2 is used for the negative electrode. The battery 43 before liquid injection is assembled in the same manner as the battery 41 before liquid injection except that Sample 3 is used for the negative electrode. The battery 48 before liquid injection is assembled in the same manner as the battery 41 before liquid injection except that Sample 8 is used for the negative electrode. The battery 49 before liquid injection is assembled in the same manner as the battery 41 before liquid injection except that Sample 9 is used for the negative electrode. The battery 50 before liquid injection is assembled in the same manner as the battery 41 before liquid injection except that Sample 10 is used for the negative electrode. The battery 51 before liquid injection is assembled in the same manner as the battery 41 before liquid injection except that Sample 11 is used for the negative electrode.

(Assembly of Battery 60 to 62 Before Liquid Injection)

The battery 60, 61, and 62 before liquid injection are assembled in the same manner as the battery 1 before liquid injection except that the anion-exchange membrane 2 is used as an anion-exchange membrane. Meanwhile, for the negative electrode of the battery 60, 61, and 62 before liquid injection, Sample 1, 2, and 8 are used, respectively.

(Liquid Injection of Electrolyte Solution 1 to “Battery 1 Before Liquid Injection”)

By injecting the electrolyte solution 1 (0.5 M aqueous KOH solution) to the side of the negative electrode and the electrolyte solution 1 (0.5 M aqueous KOH solution) to the side of the positive electrode of the “battery 1 before liquid injection” and closing the closing cap of the nozzle, the battery 1-1 is prepared.

(Liquid Injection of Electrolyte Solution 2 to “Battery 1 Before Liquid Injection”)

The battery 1-2 is prepared in the same manner as the battery 1-1 except that the electrolyte solution 2 (1.0 M aqueous KOH solution) is injected to the side of the positive electrode.

(Liquid Injection of Electrolyte Solution 3 to “Battery 1 Before Liquid Injection”)

The battery 1-3 is prepared in the same manner as the battery 1-1 except that the electrolyte solution 3 (3.0 M aqueous KOH solution) is injected to the side of the positive electrode.

(Liquid Injection of Electrolyte Solution 4 to “Battery 1 Before Liquid Injection”)

The battery 1-4 is prepared in the same manner as the battery 1-1 except that the electrolyte solution 4 (6.0 M aqueous KOH solution) is injected to the side of the positive electrode.

(Liquid injection of Electrolyte Solution 5 to “Battery 1 Before Liquid Injection”)

The battery 1-5 is prepared by injecting the electrolyte solution 2 (1.0 M aqueous KOH solution) to the side of the negative electrode and the electrolyte solution 2 (1.0 M aqueous KOH solution) to the side of the positive electrode of the “battery 1 before liquid injection”.

(Liquid Injection of Electrolyte Solution 6 to “Battery 1 Before Liquid Injection”)

The battery 1-6 is prepared in the same manner as the battery 1-5 except that the electrolyte solution 3 (3.0 M aqueous KOH solution) is injected to the side of the positive electrode.

(Liquid Injection of Electrolyte Solution 7 to “Battery 1 Before Liquid Injection”)

The battery 1-7 is prepared in the same manner as the battery 1-5 except that the electrolyte solution 4 (6.0 M aqueous KOH solution) is injected to the side of the positive electrode.

(Liquid Injection of Electrolyte Solution 8 to “Battery 1 Before Liquid Injection”)

The battery 1-8 is prepared by injecting the electrolyte solution 3 (3.0 M aqueous KOH solution) to the side of the negative electrode and the electrolyte solution 3 (3.0 M aqueous KOH solution) to the side of the positive electrode of the “battery 1 before liquid injection”.

(Liquid Injection of Electrolyte Solution 9 to “Battery 1 Before Liquid Injection”)

The battery 1-9 is prepared in the same manner as the battery 1-8 except that the electrolyte solution 4 (6.0 M aqueous KOH solution) is injected to the side of the positive electrode.

(Liquid Injection of Electrolyte Solution 1 to 9 to “Battery 2 Before Liquid Injection”)

The battery 2-1 is prepared in the same manner as the battery 1-1 except that the “battery 1 before liquid injection” is changed to the “battery 2 before liquid injection”. The battery 2-2 is prepared in the same manner as the battery 1-2 except that the “battery 1 before liquid injection” is changed to the “battery 2 before liquid injection”. The battery 2-3 is prepared in the same manner as the battery 1-3 except that the “battery 1 before liquid injection” is changed to the “battery 2 before liquid injection”. The battery 2-4 is prepared in the same manner as the battery 1-4 except that the “battery 1 before liquid injection” is changed to the “battery 2 before liquid injection”. The battery 2-5 is prepared in the same manner as the battery 1-5 except that the “battery 1 before liquid injection” is changed to the “battery 2 before liquid injection”. The battery 2-6 is prepared in the same manner as the battery 1-6 except that the “battery 1 before liquid injection” is changed to the “battery 2 before liquid injection”. The battery 2-7 is prepared in the same manner as the battery 1-7 except that the “battery 1 before liquid injection” is changed to the “battery 2 before liquid injection”. The battery 2-8 is prepared in the same manner as the battery 1-8 except that the “battery 1 before liquid injection” is changed to the “battery 2 before liquid injection”. The battery 2-9 is prepared in the same manner as the battery 1-9 except that the “battery 1 before liquid injection” is changed to the “battery 2 before liquid injection”.

(Liquid Injection of Electrolyte Solution to “Battery 3 Before Liquid Injection”)

The battery 3-6 is prepared by injecting the electrolyte solution 2 (1.0 M aqueous KOH solution) to the side of the negative electrode and the electrolyte solution 3 (3.0 M aqueous KOH solution) to the side of the positive electrode of the “battery 3 before liquid injection”.

(Liquid Injection of Electrolyte Solution to Battery 4 Before Liquid Injection)

The battery 4-6 is prepared by injecting the electrolyte solution 2 (1.0 M aqueous KOH solution) to the side of the negative electrode and the electrolyte solution 3 (3.0 M aqueous KOH solution) to the side of the positive electrode of the “battery 4 before liquid injection”.

(Liquid Injection of Electrolyte Solution to “Battery 5 Before Liquid Injection”)

The battery 5-6 is prepared by injecting the electrolyte solution 2 (1.0 M aqueous KOH solution) to the side of the negative electrode and the electrolyte solution 3 (3.0 M aqueous KOH solution) to the side of the positive electrode of the “battery 5 before liquid injection”.

(Liquid Injection of Electrolyte Solution to “Battery 6 Before Liquid Injection”)

The battery 6-6 is prepared by injecting the electrolyte solution 2 (1.0 M aqueous KOH solution) to the side of the negative electrode and the electrolyte solution 3 (3.0 M aqueous KOH solution) to the side of the positive electrode of the “battery 6 before liquid injection”.

(Liquid Injection of Electrolyte Solution to “Battery 7 Before Liquid Injection”)

The battery 7-6 is prepared by injecting the electrolyte solution 2 (1.0 M aqueous KOH solution) to the side of the negative electrode and the electrolyte solution 3 (3.0 M aqueous KOH solution) to the side of the positive electrode of the “battery 7 before liquid injection”.

(Liquid Injection of Electrolyte Solution to “Battery 8 Before Liquid Injection”)

The battery 8-1 is prepared in the same manner as the battery 1-1 except that the “battery 1 before liquid injection” is changed to the “battery 8 before liquid injection”. The battery 8-2 is prepared in the same manner as the battery 1-2 except that the “battery 1 before liquid injection” is changed to the “battery 8 before liquid injection”. The battery 8-3 is prepared in the same manner as the battery 1-3 except that the “battery 1 before liquid injection” is changed to the “battery 8 before liquid injection”. The battery 8-4 is prepared in the same manner as the battery 1-4 except that the “battery 1 before liquid injection” is changed to the “battery 8 before liquid injection”. The battery 8-5 is prepared in the same manner as the battery 1-5 except that the “battery 1 before liquid injection” is changed to the “battery 8 before liquid injection”. The battery 8-6 is prepared in the same manner as the battery 1-6 except that the “battery 1 before liquid injection” is changed to the “battery 8 before liquid injection”. The battery 8-7 is prepared in the same manner as the battery 1-7 except that the “battery 1 before liquid injection” is changed to the “battery 8 before liquid injection”.

The battery 8-8 is prepared in the same manner as the battery 1-8 except that the “battery 1 before liquid injection” is changed to the “battery 8 before liquid injection”. The battery 8-9 is prepared in the same manner as the battery 1-9 except that the “battery 1 before liquid injection” is changed to the “battery 8 before liquid injection”.

(Liquid Injection of Electrolyte Solution to “Battery 9 Before Liquid Injection”)

The battery 9-6 is prepared by injecting the electrolyte solution 2 (1.0 M aqueous KOH solution) to the side of the negative electrode and the electrolyte solution 3 (3.0 M aqueous KOH solution) to the side of the positive electrode of the “battery 9 before liquid injection”.

(Liquid Injection of Electrolyte Solution to “Battery 10 Before Liquid Injection”)

The battery 10-6 is prepared by injecting the electrolyte solution 2 (1.0 M aqueous KOH solution) to the side of the negative electrode and the electrolyte solution 3 (3.0 M aqueous KOH solution) to the side of the positive electrode of the “battery 10 before liquid injection”.

(Liquid Injection of Electrolyte Solution to “Battery 11 Before Liquid Injection”)

The battery 11-6 is prepared by injecting the electrolyte solution 2 (1.0 M aqueous KOH solution) to the side of the negative electrode and the electrolyte solution 3 (3.0 M aqueous KOH solution) to the side of the positive electrode of the “battery 11 before liquid injection”.

(Liquid Injection of Electrolyte Solution to “Battery 22 Before Liquid Injection”)

The battery 22-1 is prepared by injecting the electrolyte solution 1 (0.5 M aqueous KOH solution) to the side of the negative electrode and the electrolyte solution 1 (0.5 M aqueous KOH solution) to the side of the positive electrode of the “battery 22 before liquid injection”.

(Liquid Injection of Electrolyte Solution to “Battery 22 Before Liquid Injection”)

The battery 22-5 is prepared by injecting the electrolyte solution 2 (1.0 M aqueous KOH solution) to the side of the negative electrode and the electrolyte solution 2 (1.0 M aqueous KOH solution) to the side of the positive electrode of the “battery 22 before liquid injection”.

(Liquid Injection of Electrolyte Solution to “Battery 22 Before Liquid Injection”)

The battery 22-6 is prepared by injecting the electrolyte solution 2 (1.0 M aqueous KOH solution) to the side of the negative electrode and the electrolyte solution 3 (3.0 M aqueous KOH solution) to the side of the positive electrode of the “battery 22 before liquid injection”.

(Liquid Injection of Electrolyte Solution to “Battery 22 Before Liquid Injection”)

The battery 22-8 is prepared by injecting the electrolyte solution 3 (3.0 M aqueous KOH solution) to the side of the negative electrode and the electrolyte solution 3 (3.0 M aqueous KOH solution) to the side of the positive electrode of the “battery 22 before liquid injection”.

(Liquid Injection of Electrolyte Solution to “Battery 42 Before Liquid Injection”)

The battery 42-11 is prepared by injecting the electrolyte solution 6 (7.0 M aqueous KOH solution) to the side of the negative electrode and the electrolyte solution 6 (7.0 M aqueous KOH solution) to the side of the positive electrode of the “battery 42 before liquid injection”.

(Liquid Injection of Electrolyte Solution to “Battery 42 Before Liquid Injection”)

The battery 42-1 is prepared by injecting the electrolyte solution 1 (0.5 M aqueous KOH solution) to the side of the negative electrode and the electrolyte solution 1 (0.5 M aqueous KOH solution) to the side of the positive electrode of the “battery 42 before liquid injection”.

(Liquid Injection of Electrolyte Solution to “Battery 42 Before Liquid Injection”)

The battery 42-5 is prepared by injecting the electrolyte solution 2 (1.0 M aqueous KOH solution) to the side of the negative electrode and the electrolyte solution 2 (1.0 M aqueous KOH solution) to the side of the positive electrode of the “battery 42 before liquid injection”.

(Liquid Injection of Electrolyte Solution to “Battery 42 Before Liquid Injection”)

The battery 42-8 is prepared by injecting the electrolyte solution 3 (3.0 M aqueous KOH solution) to the side of the negative electrode and the electrolyte solution 3 (3.0 M aqueous KOH solution) to the side of the positive electrode of the “battery 42 before liquid injection”.

(Liquid Injection of Electrolyte Solution to “Battery 61 Before Liquid Injection”)

The battery 61-11 is prepared by injecting the electrolyte solution 6 (7.0 M aqueous KOH solution) to the side of the negative electrode and the electrolyte solution 6 (7.0 M aqueous KOH solution) to the side of the positive electrode of the “battery 61 before liquid injection”.

(Liquid Injection of Electrolyte Solution to Battery 61 Before Liquid Injection)

The battery 61-12 is prepared by injecting the electrolyte solution 5 (2.0 M aqueous KOH solution) to the side of the negative electrode and the electrolyte solution 6 (7.0 M aqueous KOH solution) to the side of the positive electrode of the “battery 61 before liquid injection”.

(Liquid Injection of Electrolyte Solution to “Battery 61 Before Liquid Injection”)

The battery 61-13 is prepared by injecting the electrolyte solution 2 (1.0 M aqueous KOH solution) to the side of the negative electrode and the electrolyte solution 6 (7.0 M aqueous KOH solution) to the side of the positive electrode of the “battery 61 before liquid injection”.

(Liquid Injection of Electrolyte Solution to “Battery 61 Before Liquid Injection”)

The battery 61-14 is prepared by injecting the electrolyte solution 1 (0.5 M aqueous KOH solution) to the side of the negative electrode and the electrolyte solution 6 (7.0 M aqueous KOH solution) to the side of the positive electrode of the “battery 61 before liquid injection”.

(Liquid Injection of Electrolyte Solution to “Battery 61 Before Liquid Injection”)

The battery 61-15 is prepared by injecting the electrolyte solution 5 (2 M aqueous KOH solution) to the side of the negative electrode and the electrolyte solution 5 (2.0 M aqueous KOH solution) to the side of the positive electrode of the “battery 61 before liquid injection”.

(Liquid Injection of Electrolyte Solution to “Battery 61 Before Liquid Injection”)

The battery 61-16 is prepared by injecting the electrolyte solution 2 (1 M aqueous KOH solution) to the side of the negative electrode and the electrolyte solution 5 (2.0 M aqueous KOH solution) to the side of the positive electrode of the “battery 61 before liquid injection”.

(Liquid Injection of Electrolyte Solution to “Battery 61 Before Liquid Injection”)

The battery 61-17 is prepared by injecting the electrolyte solution 1 (0.5 M aqueous KOH solution) to the side of the negative electrode and the electrolyte solution 5 (2.0 M aqueous KOH solution) to the side of the positive electrode of the “battery 61 before liquid injection”.

(Liquid Injection of Electrolyte Solution to “Battery 61 Before Liquid Injection”)

The battery 61-18 is prepared by injecting the electrolyte solution 2 (1 M aqueous KOH solution) to the side of the negative electrode and the electrolyte solution 2 (1.0 M aqueous KOH solution) to the side of the positive electrode of the “battery 61 before liquid injection”.

(Liquid Injection of Electrolyte Solution to “Battery 61 Before Liquid Injection”)

The battery 61-19 is prepared by injecting the electrolyte solution 1 (0.5 M aqueous KOH solution) to the side of the negative electrode and the electrolyte solution 2 (1.0 M aqueous KOH solution) to the side of the positive electrode of the “battery 61 before liquid injection”.

(Liquid Injection of Electrolyte Solution to “Battery 62 Before Liquid Injection”)

The battery 62-11 is prepared by injecting the electrolyte solution 6 (7.0 M aqueous KOH solution) to the side of the negative electrode and the electrolyte solution 6 (7.0 M aqueous KOH solution) to the side of the positive electrode of the “battery 62 before liquid injection”.

(Liquid Injection of Electrolyte Solution to “Battery 62 Before Liquid Injection”)

The battery 62-12 is prepared by injecting the electrolyte solution 5 (2.0 M aqueous KOH solution) to the side of the negative electrode and the electrolyte solution 6 (7.0 M aqueous KOH solution) to the side of the positive electrode of the “battery 62 before liquid injection”.

(Liquid Injection of Electrolyte Solution to “Battery 62 Before Liquid Injection”)

The battery 62-13 is prepared by injecting the electrolyte solution 2 (1.0 M aqueous KOH solution) to the side of the negative electrode and the electrolyte solution 6 (7.0 M aqueous KOH solution) to the side of the positive electrode of the “battery 62 before liquid injection”.

(Liquid Injection of Electrolyte Solution to “Battery 62 Before Liquid Injection”)

The battery 62-14 is prepared by injecting the electrolyte solution 1 (0.5 M aqueous KOH solution) to the side of the negative electrode and the electrolyte solution 6 (7.0 M aqueous KOH solution) to the side of the positive electrode of the “battery 62 before liquid injection”.

(Liquid Injection of Electrolyte Solution to “Battery 62 Before Liquid Injection”)

The battery 62-15 is prepared by injecting the electrolyte solution 5 (2 M aqueous KOH solution) to the side of the negative electrode and the electrolyte solution 5 (2.0 M aqueous KOH solution) to the side of the positive electrode of the “battery 62 before liquid injection”.

(Liquid Injection of Electrolyte Solution to “Battery 62 Before Liquid Injection”)

The battery 62-16 is prepared by injecting the electrolyte solution 2 (1 M aqueous KOH solution) to the side of the negative electrode and the electrolyte solution 5 (2.0 M aqueous KOH solution) to the side of the positive electrode of the “battery 62 before liquid injection”.

(Liquid Injection of Electrolyte Solution to “Battery 62 Before Liquid Injection”)

The battery 62-17 is prepared by injecting the electrolyte solution 1 (0.5 M aqueous KOH solution) to the side of the negative electrode and the electrolyte solution 5 (2.0 M aqueous KOH solution) to the side of the positive electrode of the “battery 62 before liquid injection”.

(Liquid Injection of Electrolyte Solution to “Battery 62 Before Liquid Injection”)

The battery 62-18 is prepared by injecting the electrolyte solution 2 (1 M aqueous KOH solution) to the side of the negative electrode and the electrolyte solution 2 (1.0 M aqueous KOH solution) to the side of the positive electrode of the “battery 62 before liquid injection”.

(Liquid Injection of Electrolyte Solution to “Battery 62 Before Liquid Injection”)

The battery 62-19 is prepared by injecting the electrolyte solution 1 (0.5 M aqueous KOH solution) to the side of the negative electrode and the electrolyte solution 2 (1.0 M aqueous KOH solution) to the side of the positive electrode of the “battery 62 before liquid injection”.

(Liquid Injection of Electrolyte Solution to “Battery 60 Before Liquid Injection”)

The battery 60-11 is prepared by injecting the electrolyte solution 2 (1.0 M aqueous KOH solution) to the side of the negative electrode and the electrolyte solution 2 (1.0 M aqueous KOH solution) to the side of the positive electrode of the “battery 60 before liquid injection”.

(Evaluation of Air Battery Performance)

<Discharge Test>

The air battery fabricated as described above is connected to a charge/discharge tester (manufactured by Toyo System Corp., product name: TOSCAT-3000U), and is subjected to constant current discharge (i.e., CC discharge) while maintaining the current density of 5 mA/cm² at the aluminum negative electrode. The cut off voltage is set at 0.5 V.

(Discharge Capacity)

Measurement results of the discharge test for the battery 61 are given in Table 2. Measurement results of the discharge test for the battery 62 are given in Table 3. Meanwhile, the expression “Concentration of electrolyte solution” described in Tables 2 and 3 means the concentration of an electrolyte (KOH) in an electrolyte solution.

TABLE 2

| | Concentration of | | | | |
|---|---|---|---|---|---|
| | electrolyte solution | | Aluminum alloy (Sample 2) | | |
| | Positive | | | Discharge | Energy |
| | electrode | Negative | | capacity | density |
| Battery | catalyst | electrode | Voltage V | mAh/g | mWh/g |
| 61-11 | 7M | 7M | 1.65 | 1450 | 2393 |
| 61-12 | 7M | 2M | 1.53 | 2150 | 3290 |
| 61-13 | 7M | 1M | 1.42 | 2550 | 3621 |
| 61-14 | 7M | 0.5M | 1.20 | 2550 | 3060 |
| 61-15 | 2M | 2M | 1.45 | 2430 | 3524 |
| 61-16 | 2M | 1M | 1.40 | 2600 | 3640 |
| 61-18 | 1M | 1M | 1.30 | 2550 | 3315 |
| 61-19 | 1M | 0.5M | 1.07 | 2500 | 2675 |

TABLE 3

| | Concentration of | | | | |
|---|---|---|---|---|---|
| | electrolyte solution | | Aluminum alloy (Sample 8) | | |
| | Positive | | | Discharge | Energy |
| | electrode | Negative | | capacity | density |
| Battery | catalyst | electrode | Voltage V | mAh/g | Wh/g |
| 62-11 | 7M | 7M | 1.25 | 200 | 250 |
| 62-12 | 7M | 2M | 1.20 | 500 | 600 |
| 62-13 | 7M | 1M | 1.17 | 1200 | 1404 |
| 62-14 | 7M | 0.5M | 1.10 | 1600 | 1760 |
| 62-15 | 2M | 2M | 1.20 | 600 | 720 |
| 62-16 | 2M | 1M | 1.20 | 1200 | 1440 |
| 62-17 | 2M | 0.5M | 1.17 | 1740 | 2036 |
| 62-18 | 1M | 1M | 1.10 | 1230 | 1353 |
| 62-19 | 1M | 0.5M | 1.00 | 1900 | 1900 |

The followings are found from Table 2. As it is evident from the comparison of the battery 61-18 and the battery 61-13, increased concentration of the electrolyte solution in the side of the positive electrode enables the discharge voltage to be increased while the discharge capacity is maintained at almost the same level. As a result, the energy density of the battery was increased from 3315 mWh/g (battery 61-18 to 3621 mWh/g (battery 61-13). As it is evident from the comparison of the battery 61-18 and the battery 61-16, increased concentration of the electrolyte solution in the side of the positive electrode enabled the discharge voltage to be increased while the discharge capacity is maintained at almost the same level. As a result, the energy density of the battery was increased from 3315 mWh/g (battery 61-18) to 3640 mWh/g (battery 61-16).

The followings are found from Table 3. As it is evident from the comparison of the battery 62-18 and the battery 62-19, decreased concentration of the electrolyte solution in the side of the negative electrode enabled the discharge capacity to be significantly increased while the discharge voltage dropped by 0.1 V. As a result, the energy density of the battery was increased from 1353 mWh/g (battery 62-18) to 1900 mWh/g (battery 62-19). As it is evident from the comparison of the battery 62-18 and the battery 62-13, increased concentration of the electrolyte solution in the side of the positive electrode enabled the energy density of the battery to be increased from 1353 mWh/g (battery 62-18) to 1404 mWh/g (battery 62-13). As it is evident from the comparison of the battery 62-18 and the battery 62-16, increased concentration of the electrolyte solution in the side of the positive electrode enabled the energy density of the battery to be increased from 1353 mWh/g (battery 62-18) to 1440 mWh/g (battery 62-16).

As illustrated above, for the battery 61 equipped with the negative electrode sample 2 in which the electrolyte solution (in the side of the negative electrode) was the electrolyte solution 2 (1.0 M aqueous KOH solution) and the discharge capacity was close to the theoretical capacity (2980 mAh/g), the energy density was improved according to an increase in concentration of the electrolyte solution in the side of the positive electrode catalyst. Further, for the battery 62 equipped with negative electrode sample 8 in which the electrolyte solution (in the side of the positive electrode) was the electrolyte solution 2 (1.0 M aqueous KOH solution) and the discharge capacity was approximately half of the theoretical capacity (2980 mAh/g), the energy density was improved by a decrease in concentration of the electrolyte solution in the side of the negative electrode.

(Analysis of Electrolyte Solution After Discharge Capacity Test)

After performing the discharge test of the battery 60-11, the electrolyte solution was recovered and the aluminum concentration of the electrolyte solution was quantified by ICP-AES. As a result, it was found that the content of aluminum contained in the electrolyte solution in the side of the positive electrode catalyst was ¼ of the aluminum contained in the electrolyte solution in the side of the negative electrode. This result indicates that, by the existence of the anion-exchange membrane, the migration amount of the negative electrode discharge product produced by discharge in the side of the negative electrode to the side of the positive electrode catalyst is significantly suppressed so that contamination (poisoning) of the positive electrode catalyst by the negative electrode discharge product can be suppressed.

(Discharge Test of Battery 42-11)

The battery 42-11 was fabricated in the same manner as the battery 61-11 except that the anion-exchange membrane is changed to a hydrophilic PTFE porous film. Discharge test of the battery 42-11 was performed. As a result, discharge capacity of the battery 42-11 was found to be almost the same as the battery 61-11. However, the discharge voltage of the battery 42-11 was dropped to 1.60 V compared to 1.65 V of the battery 61-11. This is believed due to the fact that the negative electrode discharge product migrates to the positive electrode catalyst and suppresses the uptake reaction of oxygen into the positive electrode catalyst in the battery 42-11. In addition, it was tried to fabricate a battery having lower concentration of the electrolyte solution in the side of the negative electrode compared to the battery 42-11. However, in the resulting battery, concentration of the electrolyte solution in the side of the positive electrode becomes identical to the concentration of the electrolyte solution in the side of the negative electrode, and as a result, it was difficult to lower concentration of the electrolyte solution in the side of the negative electrode compared to the concentration of the electrolyte solution in the side of the positive electrode; thereby in a battery having lower concentration of the electrolyte solution in the side of the negative electrode than the battery 42-11, self-corrosion of the aluminum negative electrode was not able to be suppressed. In a normal porous film, the electrolytes freely move through the film because the film has no anion-exchange ability. Thus, concentration difference of the electrolyte solution cannot be established between a positive electrode and a negative electrode so that the energy density of a battery cannot be increased.

(Polymer Compound Having Quaternary Ammonium Group)

The polymer compound having a quaternary ammonium group that can be used as an electrolyte is in a solution state. Thus, the polymer compound having a quaternary ammonium group in the air battery is not in membrane state. For such reasons, concentration of the electrolyte solution in the side of the negative electrode cannot be lowered than the positive electrode, and thus self-corrosion of the aluminum negative electrode cannot be suppressed.

It was confirmed based on the above that, compared to an air battery not equipped with an anion-exchange membrane, the aluminum air battery equipped with an anion-exchange membrane is capable of suppressing self-corrosion of an aluminum negative electrode, having concentration difference of an electrolyte solution between the side of the positive electrode catalyst and the side of the negative electrode, and thus is capable of having high battery energy density.

### INDUSTRIAL APPLICABILITY

As explained above, the aluminum air battery according to the present invention is capable of suppressing easily self-corrosion of the aluminum alloy as a negative electrode and increasing easily the energy density of the air battery. Thus, the aluminum air battery according to the present invention is industrially very useful and it is expected to be commercialized as a power source for an electric vehicle, a power source for a (portable) electronic device, or a source for hydrogen generation (fuel cell), for example.

### REFERENCE SIGNS LIST

1 . . . Battery before liquid injection
1a . . . Laminate (positive electrode side unit)
1b . . . Sealed laminate
100 . . . Negative electrode
100a . . . Aluminum alloy
100b . . . Imide tape
100c . . . Lead wire
2 . . . Positive electrode material containing positive electrode catalyst
4 . . . Positive electrode current collector
6 . . . Oxygen diffusion membrane
8 . . . Nickel ribbon terminal
109 . . . Air inlet
111 . . . Positive electrode cover
112 . . . Rubber packing with holes
113 . . . Positive electrode attached with oxygen selective permeable membrane
113a . . . Positive electrode
113b . . . Positive electrode attached with oxygen diffusion membrane
114 . . . Rubber packing with holes
115 . . . Anion-exchange membrane
117 . . . Negative electrode bath frame
130 . . . Negative electrode cover
150 . . . Nozzle attached with closing cap
160a . . . Electrolyte solution in side of positive electrode
160b . . . Electrolyte solution in side of negative electrode

1. An aluminum air battery comprising a positive electrode having a positive electrode catalyst, a negative electrode using an aluminum alloy, an air inlet, and an electrolyte solution, and comprising:
an anion-exchange membrane arranged between the positive electrode and the negative electrode;
wherein the anion-exchange membrane separates an electrolyte solution in the side of the positive electrode from an electrolyte solution in the side of the negative electrode.

2. The aluminum air battery according to claim 1, wherein the anion-exchange membrane has an anion-exchange capacity of 0.5 to 3.0 milliequivalents/g.

3. The aluminum air battery according to claim 1, wherein the anion-exchange membrane is an anion-exchange resin selected from the group consisting of polysulfone, polyether sulfone, polyphenyl sulfone, polyvinylidene fluoride, polyimide, and a mixture thereof.

4. The aluminum air battery according t, claim 1, wherein the anion-exchange membrane is an anion-exchange resin selected from the group consisting of styrene, divinylbenzene, a mixture thereof, and a copolymer thereof.

5. The aluminum air battery according to claim 1, wherein the electrolyte solution in the side of the positive electrode, the solution having been separated by the anion-exchange membrane, has a hydrogen ion concentration different from a hydrogen ion concentration the electrolyte solution in the side of the negative electrode has.

6. The aluminum air battery according to claim 1, wherein the electrolyte solution is an aqueous solution containing as an electrolyte at least one selected from the group consisting of KOH, NaOH, LiOH, Ba(OH)₂, and Mg(OH)₂.

7. The aluminum air battery according to claim 1, wherein the positive electrode catalyst contains manganese dioxide or platinum.

8. The aluminum air battery according to claim 1,
wherein the positive electrode catalyst contains Perovskite type composite oxide represented by ABO₃,
wherein the A site includes two or more elements selected from the group consisting of La, Sr, and Ca, and
the B site includes one or more elements selected from the group consisting of Mn, Fe, Cr, and Co.

9. The aluminum air battery according to claim 1,
wherein the aluminum alloy has a magnesium content of 0.0001% by weight to 8% by weight,
the aluminum alloy satisfies one or more of the following conditions (A) or (B), and
of among the elements contained in the aluminum alloy, a content of each element other than aluminum, magnesium, silicon, and iron is 0.005% by weight or less for each,
condition (A): the aluminum alloy has an iron content of 0.0001% by weight to 0.03% by weight, and
condition (B): the aluminum alloy has a silicon content of 0.0001% by weight to 0.02% by weight.

10. The aluminum air battery according to claim 1, wherein the aluminum alloy has a total content of elements other than aluminum and magnesium of 0.1% by weight or less.

11. The aluminum air battery according to claim 1,
wherein the aluminum alloy contains intermetallic compound particles in an alloy matrix,
of among the intermetallic compound particles observed in the surface of the aluminum alloy,
a density of the intermetallic compound particles having cross sectional area of 0.1 μm² or more and less than 100 μm² is1000 particles/mm² or less,
a density of the intermetallic compound particles having cross sectional area of 100 μm² or more is 10 particles/mm² or less, and
an area of occupancy of the intermetallic compound particles per unit surface area of the aluminum alloy is 0.5% or less.

12. The aluminum air battery according to claim 1, wherein an oxygen selective permeable membrane is installed so that oxygen taken into the air inlet can permeate to reach the positive electrode.

13. The aluminum air battery according to claim 12, wherein the electrolyte solution has a contact angle with the surface of the oxygen selective permeable membrane of 90° or more.

14. The aluminum air battery according to claim 12, wherein the electrolyte solution has a contact angle with the surface of the oxygen selective permeable membrane of 150° or more.

15. The aluminum air battery according to claim 12, wherein the oxygen selective permeable membrane has an oxygen selective coefficient PO₂ of 400×10⁻¹⁰ cm³·cm/cm²·s·cmHg or more.

16. The aluminum air battery according to claim 12, wherein PO₂/PCO₂, which is a ratio of the oxygen selective coefficient PO₂ of the oxygen selective permeable membrane to a carbon dioxide selective coefficient PCO₂ of the oxygen selective permeable membrane, is 0.15 or more.

17. The aluminum air battery according to claim 1, wherein the electrolyte solution circulates.
